(19) United States
(12) Patent Application Publication
(10) Pub. No.: US 2017/0215622 A1
(43) Pub. Date: Aug. 3, 2017

(54) COOKING UTENSIL COMPRISING BASE PRODUCED USING A VACUUM

(71) Applicant: Dusko MARAVIC, Basel (CH)

(72) Inventor: Dusko MARAVIC, Basel (CH)

(21) Appl. No.: 15/308,542

(22) PCT Filed: May 3, 2015
(86) PCT No.: PCT/CH2015/000071

§ 371 Date: Jan. 23, 2017

(30) Foreign Application Priority Data
May 4, 2014 (CH) 659/14

(51) Int. Cl. A47J 27/00; A47J 36/02

(52) U.S. Cl. CPC A47J 27/002; A47J 36/02

(57) ABSTRACT

An adhesive bituminous sheath for building includes bitumen and an adhesivizing additive mixed with the bitumen, wherein the ahesivizing additive is an aliphatic and cycloaliphatic resin.

### STATE OF THE ART

Nowadays most cooking utensils made of high-grade steel are provided with a so-called sandwich base. The technologies applied therefor exclusively include material bonding which is achieved by soldering or so-called beating. In both cases quite high temperatures have to be achieved, so that a secure connection is generated. Usually a sandwich base consists of an aluminum disc and a so-called capsule which are connected to each other by one of the procedures mentioned above. In other words, the contacting surfaces are connected by a so-called mediation. In the case of soldering this mediation is the suitable solder and in case of the so-called beating it is the atomic bonding forces which hold together the two materials. Nowadays, for obtaining a sandwich base a relatively high energy consumption is required.

That a connection of the base parts or their surfaces respectively can also been achieved by vacuum, is shown by this invention. Up until now such a solution has not been known for the production of cooking vessels.

### BRIEF DESCRIPTION OF THE DRAWINGS

FIG. 1 shows the configuration of a base of a cooking vessel which enables the contacting by means of a vacuum.

### DESCRIPTION OF THE INVENTION

A remark in advance: to apply the disclosed invention to cooking vessels which are produced according to the present methods is almost impossible. Not any reasonably thinking manufacturer of cook ware would want to apply such a method. First because it is too expensive and second, because it is time-consuming. In addition there is the question whether the technical embodiments to be excluded due to the given construction and material thicknesses. It has to be reiterated at this occasion that for present cooking vessels with enforced bases the connection among each other is effected solely by soldering or beating.

The disclosed invention is only applicable to cooking vessels which have been developed in recent times. The following patent applications are to be viewed in this connection: PCT/CH2001/000089, CH/741/2010, CH/294/2011, CH/317/2014, CH/0479/2014.

The invention is, thus, related only to cooking vessels with an even base. The surfaces to be connected are in principle the same as with present cooking vessels. These surfaces are: the base surface of the so-called inner vessel body, the intermediate circular disc and the so-called outer vessel body.

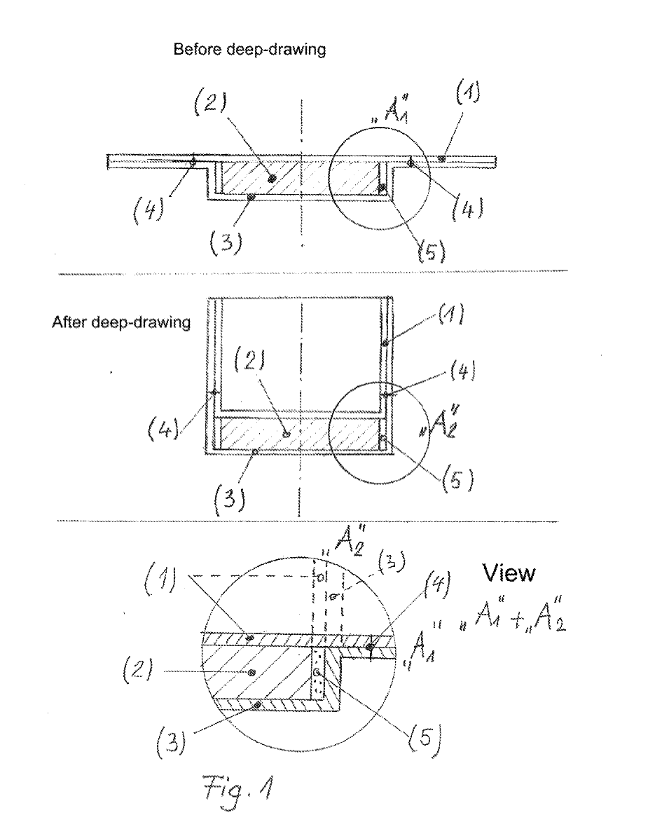

In all the patent applications mentioned above such a composition of the base is disclosed. The connection according to these documents is made in a manner different from using vacuum. As to the contact between the surfaces there is, thus, a significant difference. The present specification describes a connection which results from the effect of a vacuum. FIG. 1 shows the configuration of a base of a cooking vessel which enables the contacting by means of a vacuum.

A good full-surface contact of the surface areas of the base parts is very important. Only if the surfaces are in contact with each other and if the base as such is in good contact with heat spending surface-often glass-ceramics-an efficient heat transport is possible. If in addition the parts of the vessel base consist of materials with high heat conduction, then the heat transport across the base is optimal.

In order that the base parts can be brought into full-surface contact by the effect of the vacuum it is necessary to house the intermediate disc (2) in a closed space (5). Only then a vacuum can be generated in space (5). As the base surfaces of the outer and inner body are slightly flexible and are located close to the intermediate disc (2), they are pressed against the disc (2) by the ambient pressure. As long as a vacuum exists in the space (5) around the intermediate disc (2) the parts are in contact with each other. To this effect the vacuum does not have to be above 1.0 E(−3) to 1.0 E(−4) mbar. This vacuum is called fine vacuum. These values are easily reached with normal vacuum pumps. Any increase of the vacuum, e.g. up to extra high vacuum [more than 1.0 E(−12) mbar] does not have any advantage and is quite cost and time intensive.

How to achieve the vacuum in the closed space (5) is up to the manufacturer. Preferably a hole is made in base area (1) or (2) to obtain a connection to the vacuum pump. After the desired vacuum is reached the hole must be tightly closed, e.g. by welding.

In principle, the vacuum contact may be realized either before or after the deep-drawing. It only depends on whether the cooking vessel manufacturer is capable of making this production step himself or not. If he wants to make the vacuum contact himself, then he must have the suitable vacuum equipment, i.e. effect new expenditures, because usually cooking vessel manufacturers are not equipped with such facilities. If, however the vacuum contact is to be made by the cooking vessel manufacturer it is generally more appropriate and much less expensive to do it prior to the deep-drawing. Simple geometry and much less necessary space makes the vacuuming simpler and much cheaper.

If a cooking vessel manufacturer is not capable of doing this production step himself, then he may acquire a pre-fabricated sandwich element (so-called condurelle) from another source.

Special attention has to be given to the mechanical stability of the tight welding seam (4). In any case it must not happen that the welding seam (4) is destroyed during deep-drawing. This would automatically lead to a loss of vacuum in the space (5) surrounding the intermediate disc (2).

The maximum specific attaching pressure with which the ambient air acts onto the cooking vessel base lies in the area of 1.0 E(+5)N/m². Accordingly, a maximum attaching force of 3.14 kN is acting on a cooking vessel base with a diameter of 200 mm. With this force the plates (1) and (3) made of high-grade steel are pressed against the intermediate disc (2) in the vacuum, thereby avoiding that they lose the physical contact among each other. The contact is also not lost, if the base experiences high temperatures.

The vacuum, i.e. the reduced pressure in the space where the intermediate disc (2) is located has 10 million times less air molecules as compared to ambient air, so that in spite of a temperature increase no significant pressure change takes place. According to the kinetic gas theory the number of gas particles per volume depends on the pressure and the thermodynamic temperature. Thus, at a specific temperature the pressure of a gas depends solely on the particle density. Therefore, the use of a base including vacuum for cooking vessels is quite possible. Even if the cooking vessel is exposed to a high temperature, e.g. 300° centigrade, the vacuum in the space (5) surrounding the intermediate disc (2) is sufficient to keep all base surfaces in contact with each other.

The invention presented allows the use of various materials to be chosen for the intermediate disc (2). The main function of this disc is to guarantee the evenness of the vessel bottom. Then it should have a good heat conduction and a high mechanical stability in order to avoid a deformation of the vessel bottom by thermo-induced forces which are generated during usage. Preferably steel with a high yield strength is used, but other materials will fulfill this function as well. Since the materials which maybe considered have different characteristics, care has to be taken to compatibility with the high-grade steel. This relates especially to the difference in extension of the chosen material. With the classical connection by welding one immediately hits the limits of the mechanical stability of a tight welding seam. The shear tension which is produced by the temperature increase in the separation plane may destroy the welding seam and therefore result in the loss of the contact between the heat transport surfaces. Moreover, it has always to be considered whether the two chosen materials may be contacted by welding at all. These considerations are not important for the present invention because the parts being connected by vacuum may move relative to each other in the contact plane. For these material combinations the vacuum contacting is the ideal solution.

1. A cooking vessel having a base, in which all surfaces in the base area are held together by a vacuum, wherein an intermediate disc is situated in a space enclosed by an interior disc and an outer disc and being under vacuum are pressed against each other by the pressure forces acting from the ambient pressure.

2. The cooking vessel of claim 1, wherein the enclosed space is preferably achieved by a welding seam.

3. The cooking vessel of claim 1, wherein the vacuum in the enclosed space (−5) amounts to the preferable range of 1.0 E(−3) to 1.0 E(−4) mbar.
